(19) United States
(12) Patent Application Publication
(10) Pub. No.: US 2022/0205485 A1
(43) Pub. Date: Jun. 30, 2022

(54) AN ALUMINUM ALLOY CAGE AND A PROCESSING METHOD OF THE ALUMINUM ALLOY CAGE

(71) Applicant: Schaeffler Technologies AG & Co. KG, Herzogenaurach (DE)

(72) Inventors: Shenghua YE, Kunshau City, Jiangsu (CN); Zhenyan ZHANG, Shanghai (CN); Jianfei WEI, Shanghai (CN)

(73) Assignee: Schaeffler Technologies AG & Co. KG, Herzogenaurach (DE)

(21) Appl. No.: 17/605,622

(22) PCT Filed: Apr. 29, 2019
(86) PCT No.: PCT/CN2019/084976

§ 371 Date: Oct. 22, 2021

(51) Int. Cl. F16C 33/56; C23C 18/16; C23C 18/18; C23C 18/32; C23C 18/54; C23C 28/02; C22C 21/00

(52) U.S. Cl. CPC F16C 33/565; F16C 2300/42; C23C 18/1651; C23C 18/1662; C23C 18/1806; C23C 18/1844; C23C 18/32; C23C 18/54; C23C 28/025; C22C 21/00; F16C 2202/06; F16C 2204/20; F16C 2204/50; F16C 2204/52; F16C 2223/08; F16C 2223/40; F16C 2300/02; C23C 18/1637

(57) ABSTRACT

An aluminum alloy cage and a method for producing the same. The aluminum alloy cage has a shot-peened aluminum alloy cage substrate and a coating formed on the surface of shot-peened aluminum alloy cage substrate, the coating including at least one nickel containing layer. The aluminum alloy cage has high fatigue strength, excellent corrosion resistance, high surface hardness and low surface friction coefficient, and exhibits excellent surface lubricity and wear resistance.

### CROSS-REFERENCE TO RELATED APPLICATIONS

This application is the U.S. National Phase of PCT Appln. No. PCT/CN2019/084976, filed Apr. 29, 2019, the entire disclosures of which is incorporated by reference herein.

### TECHNICAL FIELD

The present disclosure relates to an aluminum alloy cage and a method for preparing the same. In particular, the present disclosure relates to an aluminum alloy cage having good fatigue strength, corrosion resistance, surface lubricity and wear resistance, and a method for preparing the same.

### BACKGROUND

In the field of bearings, a bearing part that partially wraps rolling elements and move therewith is called a cage (or a retainer). The main functions of rolling bearing cages are the separation and the distribution of the rolling elements. Other functions are often to prevent rolling elements from falling out of separable bearings and to guide the rolling elements in the unloaded zone of the bearing. At present, brass cages are widely used. However, brass cages have the following disadvantages or deficiencies: the density of brass is high, making it difficult to obtain a lightweight bearing; the raw material price is high, resulting in great production costs; brass contains lead which causes environmental problems.

Especially, when the lubricating oil is contaminated with hard particles, the hard particles could insert into the soft brass cage. And then the hard particles will grind the rollers which contact with the cage pocket bar, causing the bearing failure. Furthermore, if lead is removed from brass, the machining efficiency of the brass will be significantly reduced, which increases the machining cost.

At present, aluminum alloy cages can be used to replace brass cages. However, most of the existing aluminum alloy cages have no coating on the surface, resulting in unsatisfactory fatigue strength, corrosion resistance, lubricity and wear resistance. Some companies perform hard anodization to process the surface of the aluminum alloy cages. But the fatigue strength of the aluminum alloy cage after such processing is deteriorated.

### SUMMARY

### Problem to be Solved

The present disclosure intends to overcome or at least alleviate the deficiencies of the prior art described above, and to provide an aluminum alloy cage having good fatigue strength, corrosion resistance, surface lubricity and wear resistance, and a preparation method thereof.

### Technical Solution for Solving the above Problem

The processing method of the aluminum alloy cage comprises the steps of:

(1) Shot peening the surface of the aluminum alloy cage substrate;

(2) Pretreating the shot-peened surface;

(3) Optionally forming an intermediate layer on the pretreated surface;

(4) Forming at least one nickel containing layer on the substrate or on the intermediate layer.

### Effect of the Present Disclosure

The aluminum alloy cage according to the present disclosure has high fatigue strength, excellent corrosion resistance, high surface hardness and low surface friction coefficient, and exhibits excellent surface lubricity and wear resistance.

### BRIEF DESCRIPTION OF THE DRAWINGS

FIG. 1 is the test result of the shot-peened and Ni—P-PTFE coated aluminum alloy cage of Example 1 under an accelerating working condition.

FIG. 2 is the test result of the aluminum alloy cage without coating of Contrastive Example 1 under the same accelerating working condition.

FIG. 3 is the test result of the conventional brass cage of Contrastive Example 2 under the same accelerating working condition.

### DETAILED DESCRIPTION

The present disclosure relates to an aluminum alloy cage comprising a shot-peened aluminum alloy cage substrate and a coating formed on the surface of the shot-peened aluminum alloy cage substrate. The coating comprises an intermediate layer on the substrate and at least one nickel containing layer formed on the intermediate layer, or at least one nickel containing layer formed on the substrate, wherein the intermediate layer is preferably a zinc intermediate layer.

The intermediate layer firmly bonded to the aluminum alloy cage substrate and the nickel containing layer, respectively, to ensure good adhesion.

Preferably, the coating comprises an inner nickel containing layer and an outer nickel containing layer. The inner nickel containing layer is single or multi electroless nickel plating layers, or is single or multi composite electroless nickel plating layers, or is a combination of multi electroless and composite electroless nickel plating layers.

Preferably, the coating further comprises a Ni—P-PTFE layer. The Ni—P-PTFE layer contains PTFE (Poly tetra fluoroethylene) particles, which reduces the friction coefficient of the aluminum alloy cage. Moreover, the Ni—P-PTFE layer has a relatively high hardness, which improves the wear resistance of the aluminum alloy cage in use.

The present disclosure further provides a preparation method of the aluminum alloy cage, comprising the steps of:

(1) Shot peening the surface of the aluminum alloy cage substrate;

(2) Pretreating the shot-peened surface;

(3) Optionally forming an intermediate layer on the pretreated surface;

(4) Forming at least one nickel containing layer on the substrate or on the intermediate layer.

(1) Shot Peening

The shot peening is performed to full coverage at Almen intensities of 0.2-0.5 mmA, which induces residual compressive stresses of 50-280 MPa in a depth from surface of 50-200 μm.

(2) Pretreating

The pretreating step of the present disclosure includes, but not limited to, steps of chemical degreasing, and surface activation. More preferably, a step of organic degreasing is performed before the step of chemical degreasing. Each of the afore-mentioned steps is described in detail in the following paragraphs.

(2.1) Organic Degreasing

Optionally, a step of organic degreasing is performed on the surface of the aluminum alloy cage. Organic degreasing is to dissolve grease on the surface of the aluminum alloy cage in an organic solvent and remove the grease. Organic degreasing is particularly preferable when the grease on the surface of the aluminum alloy cage is relatively thick. The organic solvent is one or more than two of a group consisting of ethanol, kerosene, and gasoline or other environment friendly organic solvents. However, generally, organic degreasing is not thorough, because when the organic solvent on the surface of the substrate material volatilizes, the grease dissolved in the solvent will remain on the surface of the aluminum alloy cage. Therefore, preferably, a step of chemical degreasing is performed after the step of organic degreasing.

(2.2) Chemical Degreasing

A chemical degreasing process is employed to degrease the surface of the aluminum alloy cage in an operation temperature range from 60° C. to 80° C. The chemical degreasing solution can be alkaline or acid. Wherein, the alkaline degreasing solution contains one or more than two of a group consisting of sodium carbonate, sodium hydroxide, sodium phosphate dodecahydrate, sodium silicate and sodium borate, with a typical composition of 15-20 g/L sodium carbonate, 20-30 g/L sodium dodecahydrate and 10-15 g/L sodium silicate.

Acid degreasing gradually prevails, the bath solution contains H₂SO₄ or H₃PO₄, added HF, Fe, H₂O₂, NO and nonionic surfactant, operating at room temperature for 3-5 minutes. It has high efficiency and no pollution, which is better and more widely used than alkaline degreasing for aluminum alloy.

The method of performing the chemical degreasing is not limited herein. For example, it can be acid degreasing or alkaline degreasing, performed also by dipping, spraying, steaming, etc., or by a combination thereof.

After the step of chemical degreasing, necessary rinsing is performed to avoid contamination of the metal surface with residual chemical degreasing solution. For example, the rinsing is performed with clean water to achieve a very low concentration of the chemical degreasing solution in the rinsing liquid. Preferably, the rinsing is stopped when the concentration of the chemical degreasing solution in the rinsing liquid is less than 2% of the initial concentration of the chemical degreasing solution.

(2.3) Activation

Activation is performed on the surface of the aluminum alloy cage. Preferably, at room temperature, the aluminum alloy cage is immersed in a 50% nitric acid solution for 20-30 seconds to activate the surface of the aluminum alloy cage.

After the activation, necessary rinsing is performed to avoid corrosion of the metal surface by the residual acid solution. For example, the rinsing is performed with clean water to achieve a very low concentration of acid solution in the rinsing liquid.

(3) Forming an Intermediate Layer

After the step of pretreating the surface of the aluminum alloy cage, an intermediate layer is optionally formed on the pretreated surface. Preferably, the pretreated surface is immersed in a zinc salt solution to form the intermediate layer. This step is described in detail in the following paragraphs.

In order to closely bond the aluminum alloy cage substrate to the nickel containing layer described later, it is preferred to form an intermediate layer on the pretreated surface of the aluminum alloy cage substrate. Preferably, the pretreated surface is immersed in a zinc salt solution to form the intermediate layer. During the immersion in the zinc salt solution, an oxide film on the pretreated surface is effectively removed. The formed intermediate layer can prevent the surface from being oxidized again while allowing a tight bonding between the surface of the aluminum alloy cage substrate and the nickel plating layer.

To improve the quality of the intermediate layer, the intermediate layer is formed preferably by a method comprising the steps of:

(3.1) immersing the pretreated surface in a zinc salt solution to form a first zinc plated layer;

(3.2) removing the first zinc plated layer;

(3.3) immersing the pretreated surface in a zinc salt solution again to form a second zinc plated layer.

Preferably, the zinc content in the zinc salt solution ranges from 10 to 100 g/L, for example in form of zinc oxide. More preferably, the first zinc plated layer is removed using a nitric acid solution in the step (3.2), and the residual nitric acid solution is removed by washing with water.

The second zinc plated layer is washed with water after being formed, finally obtaining a more compact and integrate intermediate layer that has outstanding performance in the bonding with the surface of the aluminum alloy cage.

(4) Forming at least one nickel containing layer

One nickel pre-plating layer is formed on the substrate or on the intermediate layer by an alkaline bath. Then the nickel pre-plating layer is thickened by an acid bath to obtain a nickel plating layer.

Preferably, the alkaline bath has a 8.0-12.0 pH value. The nickel pre-plating layer formed by the alkaline bath effectively protects the newly formed intermediate layer from being dissolved in the bath. More preferably, the alkaline bath contains a nickel content of about 3.0-7.0 g/L.

After the nickel pre-plating layer is formed, the nickel pre-plating layer is thickened by an acid bath to obtain a nickel plating layer. Preferably, the acid bath has a pH value of 4.0-6.0. More preferably, the acid bath contains a nickel content of about 3.0-7.5 g/L.

In a preferable embodiment, after the nickel plating layer is formed, a Ni—P-PTFE layer is formed on the nickel plating layer using a plating bath containing PTFE, a nickel-containing compound, and a phosphorus-containing compound.

Preferably, PTFE particles are scattered in a plating bath containing the nickel-containing compound and the phosphorus-containing compound forming the Ni—P-PTFE layer on the nickel plating layer.

The Ni—P-PTFE layer contains PTFE particles, which reduces the wet friction coefficient of the surface of the aluminum alloy cage. For example, the wet friction coefficient of the surface of the aluminum alloy cage may be 0.08 or less. Preferably, the content of polytetrafluoroethylene in the Ni—P-PTFE layer is of 10-50% (m/m ratio). The Ni—P-PTFE layer serves to improve the hardness of the surface of the aluminum alloy cage, providing excellent wear resistance.

### EXAMPLES

### Example 1

The surface of the aluminum alloy cage substrate sequentially undergoes shot peening. The nickel pre-plating layer is formed in the alkaline bath. The nickel plating layer is formed in the acid solution. The PTFE-phosphorus-nickel layer is formed in a Ni—P-PTFE plating solution. The aluminum alloy cage obtained thereby is tested.

The detail processing parameters as following:

(1) Chemical degreasing: to removal of grease and dirt from the surface of aluminum alloy during machining: the solution contained 35 g/L sodium carbonate, 27 g/L sodium dodecahydrate, the solution temperature of 65° C., dip time of 3 min.

(2) Alkali etching: Soaking in 10% sodium hydroxide solution at 52 degrees for about 30 seconds to remove the surface oxide.

(3) Activation: at room temperature, the aluminum alloy cage is immersed in a 50% nitric acid solution for 20 to 30 seconds to removal of residual plaque from alkali etching and activate the surface of the aluminum alloy cage.

(4) Zinc dipping: technical conditions: NaOH 120 g/L, ZnO 20 g/L, stabilizer: 30 ml/L, temperature 20° C., time 45 seconds, after first zinc dipping, treated with 50% HNO₃ solution at room temperature for 10 seconds, then secondary zinc dipping, so that the zinc coating can be more uniform, higher density and better adhesion.

(5) Alkaline electroless nickel plating (alkaline Ni—P): Composition of the solution, NiSO₄.7H₂O 27 g/L, NaH₂PO₂.H₂O 26 g/L, Na₃C₆H₅O₇.H₂O 85 g/L, NH₄Cl 35 g/L, (HOCH₂CH₂)₃N 90 g/L, pH 9.3, temperature 50° C.

(6) Acid electroless nickel plating (acid Ni—P): make up EN PLATING (HP) DNC571: Ni: 5.7 g/L, NaH₂PO₂.H₂O 35 g/L, pH 4.9, temperature 90° C.

(7) Electroless nickel plating graded Ni—P-PTFE: make up ENP 3400A, pH 4.9, temperature 85-90° C.

All the above processes are washed with water. The total thickness of the coating (Ni—P/Ni—P-PTFE) is of 8.1 μm, PTFE content in Ni—P-PTFE coating is of 13% (m/m).

Performance Test

Same type bearings were assembled aluminum alloy cages without and with shot peening and Ni—P-PTFE coating and conventional brass cage, respectively, mounted on a bearing fatigue life capability test rig and then simultaneously tested under a high-speed low-load working condition to accelerate the damage on cages. The test conditions are listed as follows.

| No. | Cage | Test conditions |
|---|---|---|
| Example 1 | Aluminum alloy cage with shot- | Radial load: 2.6 kN, |
| | peening and Ni—P-PTFE coating | Speed: 6000 rpm, |
| Contrastive | Aluminum alloy cage (same with | Temperature: 40° C., |
| Example 1 | Example 1) without coating | Time: 700 h, |
| Contrastive | Conventional brass cage | Cage rolling cycles: |
| Example 2 | (Schaeffler NU215-E-MPAX) | 1 × 10⁸ |

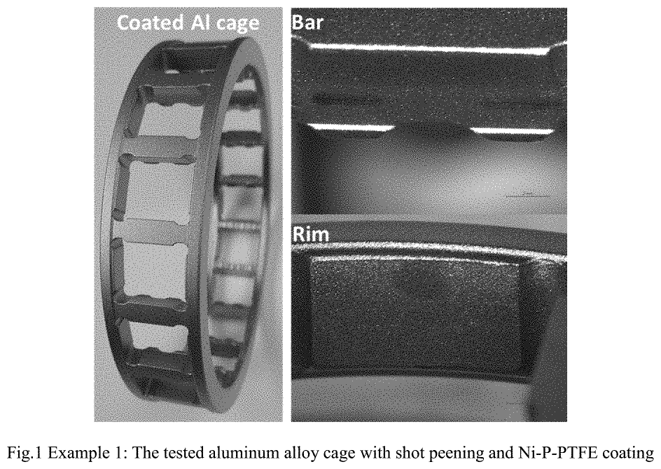

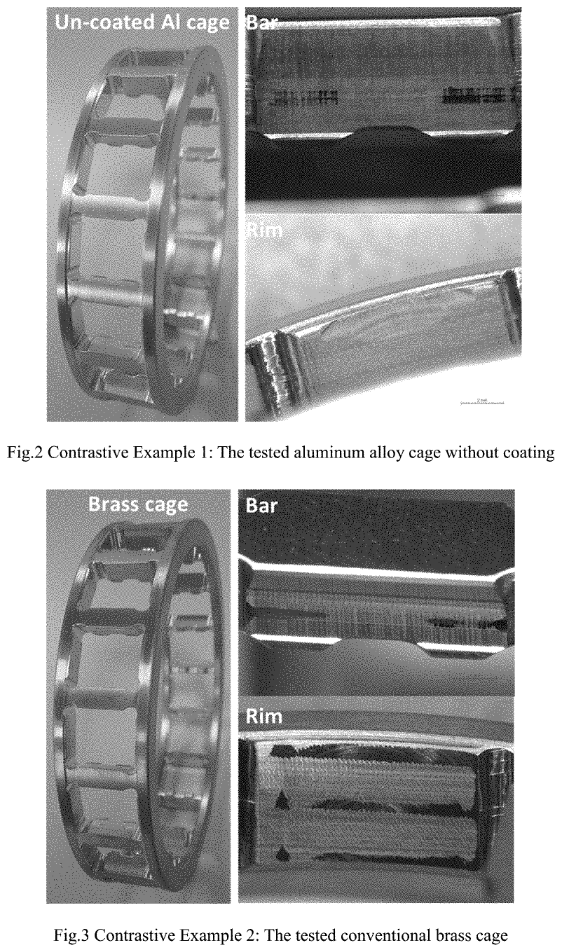

The test results are shown in FIGS. 1-3. The Example 1 cage was polished only at the areas contacting rollers and had the least wear amount, while both Contrastive Example 1 and Contrastive Example 2 wore of much more amount. The test results demonstrated that the coating has good wear resistance.

1. An aluminum alloy cage, comprising:
a shot-peened aluminum alloy cage substrate; and
a coating formed on a surface of the shot-peened aluminum alloy cage substrate, the coating comprising at least one nickel containing layer.

2. The aluminum alloy cage according to claim 1, wherein a residual compressive stresses of the shot-peened aluminum alloy cage substrate is 50 MPa to 280 MPa in a depth from the surface of 50 μm to 200 μm.

3. The aluminum alloy cage according to claim 1, wherein the coating further comprises an intermediate layer on the substrate, and the at least one nickel containing layer is formed on the intermediate layer.

4. The aluminum alloy cage according to claim 3, wherein the intermediate layer is a zinc containing layer.

5. The aluminum alloy cage according to claim 1, wherein the at least one nickel containing layer comprises an inner nickel containing layer and an outer nickel containing layer.

6. The aluminum alloy cage according to claim 5, wherein the inner nickel containing layer is a single or multi electroless nickel plating layers, or is a single or multi composite electroless nickel plating layers, or is a combination of multi electroless and composite electroless nickel plating layers.

7. The aluminum alloy cage according to claim 5, wherein the outer nickel containing layer is a Ni—P-PTFE layer formed by a bath containing PTFE, nickel-containing compounds and phosphorus-containing compounds.

8. A processing method for forming the aluminum alloy cage according to claim 1, comprising the steps of:
(1) shot peening the surface of the aluminum alloy cage substrate;
(2) pretreating the shot-peened surface;
(3) forming the coating comprising the at least one nickel containing layer.

9. The processing method according to claim 8, wherein the forming of the coating comprises:
forming the at least one nickel containing layer on the pretreated surface.

10. The processing method according to claim 9, wherein the shot peening step induces residual compressive stresses of 50 MPa to 280 MPa in a depth from the surface of 50 μm to 200 μm.

11. The processing method according to claim 8, wherein the forming of the coating comprises the steps of:
(1) forming an intermediate layer on the pretreated surface; and
(2) forming the at least one nickel containing layer on the intermediate layer.

12. The processing method according to claim 11, wherein the forming of the intermediate layer comprises the steps of:
immersing the pretreated surface in a zinc salt solution to form a first zinc plated layer;
removing the first zinc plated layer; and
immersing the pretreated surface in a zinc salt solution again to form a second zinc plated layer.

13. The processing method according to claim 12, wherein a zinc content in the zinc salt solution ranges from 10 to 100 g/L.

14. The processing method according to claim 12, wherein the removing of the first zinc plated layer comprises applying a nitric acid solution, and removing a residual nitric acid solution by washing with water.

15. The processing method according to claim 8, wherein the at least one nickel containing layer is formed in an acid solution.

16. The processing method according to claim 8, wherein the forming of the at least one nickel containing layer includes forming a nickel plating layer, and then forming a Ni—P-PTFE layer on the nickel plating layer.

17. The processing method according to claim 16, wherein a content of polytetrafluoroethylene in the Ni—P-PTFE layer is of 10-50% (m/m ratio).
